(19) United States
(12) Patent Application Publication
(10) Pub. No.: US 2025/0021305 A1
(43) Pub. Date: Jan. 16, 2025

(54) Filtering with Tensor Structures

(71) Applicant: Altera Corporation, San Jose, CA (US)

(72) Inventors: Martin Langhammer, Alderbury (GB); Volker Mauer, Princes Risborough (GB); Gregory Ives, London (GB); Dongdong Chen, San Jose, CA (US); Bogdan Pasca, Toulouse (FR)

(21) Appl. No.: 18/899,127

(22) Filed: Sep. 27, 2024

(51) Int. Cl. G06F 7/523; G06F 7/50

(52) U.S. Cl. CPC G06F 7/523; G06F 7/50

(57) ABSTRACT

Integrated circuit devices, methods, and circuitry for implementing filters based on multipliers in tensor circuits are provided. Integrated circuitry may include a first tensor circuit with a first set of multipliers of a first precision and first summation circuitry and a second tensor circuit with a second set of multipliers of a second precision and second summation circuitry. The first tensor circuit and the second tensor circuit may collectively perform a multiplication operation at a third precision higher than the first precision and the second precision.

### BACKGROUND

This disclosure relates to filtering using tensor circuits of an integrated circuit, such as tensor circuits of embedded digital signal (DSP) blocks of an integrated circuit.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Many integrated circuits include arithmetic circuit blocks to perform arithmetic operations such as addition and multiplication. For example, a digital signal processing (DSP) block may supplement programmable logic circuitry in a programmable logic device, such as a field programmable gate array (FPGA). Programmable logic circuitry and DSP blocks may be used to perform numerous different arithmetic functions. Many programmable logic devices include DSP blocks with a small number of larger multipliers (e.g., one or two 18×18 bit multipliers per DSP block) to implement certain types of filters, such as finite impulse response (FIR) filters, along with some support circuitry such as delay chains and accumulators. Thus, implementing a large filter may consume a large number of DSP blocks.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device;

FIG. 2 is a block diagram of the integrated circuit device of FIG. 1;

FIG. 3 is a block diagram of a finite impulse response (FIR) filter that may be formed using multipliers formed using tensor resources of digital signal processor (DSP) blocks of the integrated circuit device;

FIG. 4 is a diagram of two tensor blocks within a DSP block of the integrated circuit device;

FIG. 5 is a diagram of multiplication using a larger multiplier formed using multiple tensor blocks from multiple DSP blocks;

FIG. 6 is a diagram of an equivalent result of the multiplication of FIG. 5;

FIG. 7 is a block diagram of tensor blocks from two DSP blocks with additional soft logic circuitry to perform the multiplication of FIGS. 5 and 6;

FIG. 8 is a block diagram of tensor blocks from two DSP blocks with hardened logic circuitry in the DSP blocks to enable the multiplication of FIGS. 5 and 6;

FIG. 9 is a diagram of one tensor block within a DSP block of the integrated circuit device with a closer view of an arrangement of coefficient registers;

FIG. 10 is a diagram of one tensor block within a DSP block of the integrated circuit device with a chained arrangement of coefficient registers to support decimation filtering;

FIG. 11 is a diagram of one tensor block within a DSP block of the integrated circuit device with multiplexers to support the chained arrangement of FIG. 10;

FIG. 12 is a diagram of multiplication of asymmetric vectors when different tensor blocks support different precisions;

FIG. 13 is a diagram of an equivalent result of the multiplication of FIG. 12; and

FIG. 14 is a diagram of asymmetric multiplication that may be performed using multiple tensor blocks;

FIG. 15 is a diagram of an equivalent result of the asymmetric multiplication of FIG. 14;

FIG. 16 is a block diagram of tensor blocks from one DSP block used to perform the asymmetric multiplication of FIGS. 14 and 15;

FIG. 17 is a block diagram of tensor blocks from three DSP blocks used to form perform larger asymmetric multiplication; and

FIG. 18 is a block diagram of a data processing system that may incorporate the integrated circuit.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Many integrated circuits, such as programmable logic devices, include DSP blocks with hardened circuitry to carry out operations for artificial intelligence (AI). The DSP blocks include “hardened” circuits that are specialized to efficiently perform certain mathematical operations. This is in contrast to “soft” circuits that may be formed by programming programmable logic but which may not be as efficient. In the AI circuitry of the DSP blocks, there may be a large number of smaller multipliers with lower precisions than may be typically found in many DSP use cases. These may form large tensors, which compute dot products, that are implemented in the hardware of the DSP blocks. Rather than allow the AI-related circuitry of the DSP blocks simply to go unused when a programmable logic device is being used in filtering operations, this disclosure provides systems and methods for leveraging the AI-related circuitry to provide additional regular DSP functions. For example, AI tensor cores of DSP blocks may be used to perform FIR filtering, which is one of the most common applications performed on programmable logic devices. This may double (or more) the arithmetic density of FIR filters, largely by repurposing a hardened resource typically used for AI operations for digital signal processing operations instead.

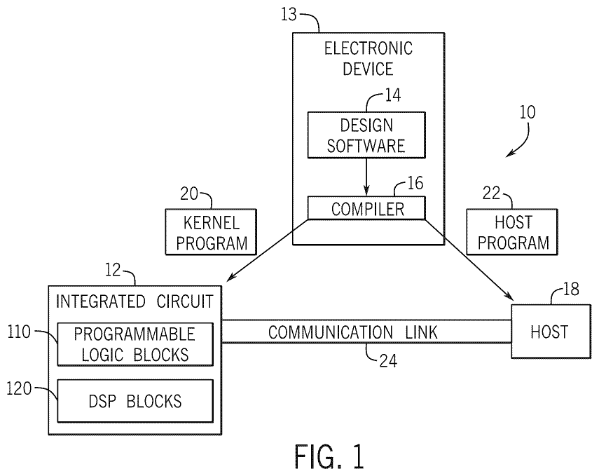

FIG. 1 illustrates a block diagram of a system 10 that may be used to implement the filtering systems and methods of this disclosure on an integrated circuit system 12 (e.g., a single monolithic integrated circuit or a multi-die system of integrated circuits). A designer may desire to implement a system design to perform filtering operations on the integrated circuit system 12 (e.g., a programmable logic device such as a field-programmable gate array (FPGA) or an application-specific integrated circuit (ASIC) that includes programmable logic circuitry). The integrated circuit system 12 may include a single integrated circuit, multiple integrated circuits in a package, or multiple integrated circuits in multiple packages communicating remotely (e.g., via wires or traces). In some cases, the designer may specify a high-level program to be implemented, such as an OPENCL® program that may enable the designer to more efficiently and easily provide programming instructions to configure a set of programmable logic cells for the integrated circuit system 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit system 12.

In a configuration mode of the integrated circuit system 12, a designer may use an electronic device 13 (e.g., a computer) to implement high-level designs (e.g., a system user design) using design software 14, such as a version of INTEL® QUARTUS® by INTEL CORPORATION. The electronic device 13 may use the design software 14 and a compiler 16 to convert the high-level program into a lower-level description (e.g., a configuration program, a bitstream). The compiler 16 may provide machine-readable instructions representative of the high-level program to a host 18 and the integrated circuit system 12. The host 18 may receive a host program 22 that may control or be implemented by the kernel programs 20. To implement the host program 22, the host 18 may communicate instructions from the host program 22 to the integrated circuit system 12 via a communications link 24 that may include, for example, direct memory access (DMA) communications or peripheral component interconnect express (PCIe) communications. In some embodiments, the kernel programs 20 and the host 18 may configure programmable logic blocks (e.g., LABs 110) on the integrated circuit system 12. The programmable logic blocks (e.g., LABs 110) may include circuitry and/or other logic elements and may be configurable to implement a variety of functions in combination with digital signal processing (DSP) blocks 120.

The designer may use the design software 14 to generate and/or to specify a low-level program, such as the low-level hardware description languages described above. Further, in some embodiments, the system 10 may be implemented without a separate host program 22. Thus, embodiments described herein are intended to be illustrative and not limiting.

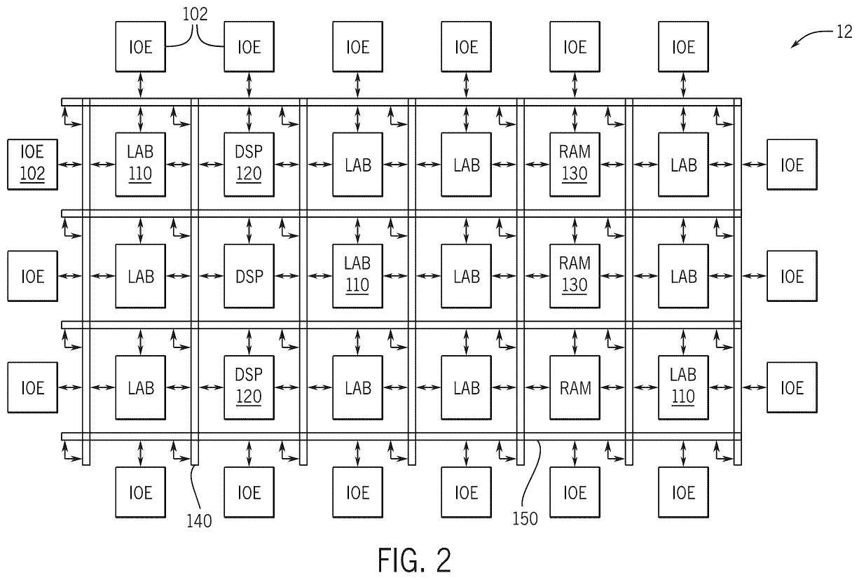

An illustrative embodiment of a programmable integrated circuit system 12 such as a programmable logic device (PLD) (e.g., a field programmable gate array (FPGA) device) that may be configurable to implement a circuit design is shown in FIG. 2. As shown in FIG. 2, the integrated circuit system 12 (e.g., a field-programmable gate array (FPGA) integrated circuit device) may include a two-dimensional array of functional blocks sometimes referred to as arithmetic logic modules (ALMs), including programmable logic blocks (e.g., also referred to as logic array blocks (LABs) 110 or configurable logic blocks (CLBs)) and other functional blocks, such as embedded digital signal processing (DSP) blocks 120 and embedded random-access memory (RAM) blocks 130, for example. Functional blocks such as LABs 110 may include smaller programmable regions (e.g., logic elements, configurable logic blocks, or adaptive logic modules) that receive input signals and perform custom functions on the input signals to produce output signals. LABs 110 may also be grouped into larger programmable regions sometimes referred to as logic sectors that are individually managed and configured by corresponding logic sector managers. The grouping of the programmable logic resources on the integrated circuit system 12 into logic sectors, logic array blocks, logic elements, or adaptive logic modules is merely illustrative. In general, the integrated circuit system 12 may include functional logic blocks of any suitable size and type, which may be organized in accordance with any suitable logic resource hierarchy.

Programmable logic of the integrated circuit system 12 may be controlled by programmable memory elements sometimes referred to as configuration random access memory (CRAM). Memory elements may be loaded with configuration data (also called programming data or a configuration bitstream) using input-output elements (IOEs) 102. Once loaded, the memory elements each provide a corresponding static control signal that controls the operation of an associated functional block (e.g., LABs 110, DSP BLOCK 120, RAM 130, or input-output elements 102).

In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory, configuration random-access memory (CRAM), or programmable memory elements. The integrated circuit system 12 (e.g., as a programmable logic device (PLD)) may be configurable to implement a custom circuit design. For example, the configuration RAM may be programmed such that LABs 110, DSP BLOCK 120, and RAM 130, programmable interconnect circuitry (i.e., vertical channels 140 and horizontal channels 150), and the input-output elements 102 form the circuit design implementation.

In addition, the programmable logic device may have input-output elements (IOEs) 102 for driving signals off the integrated circuit system 12 and for receiving signals from other devices. Input-output elements 102 may include parallel input-output circuitry, serial data transceiver circuitry, differential receiver and transmitter circuitry, or other circuitry used to connect one integrated circuit to another integrated circuit.

The integrated circuit system 12 may also include programmable interconnect circuitry in the form of vertical routing channels 140 (i.e., interconnects formed along a vertical axis of the integrated circuit system 12) and horizontal routing channels 150 (i.e., interconnects formed along a horizontal axis of the integrated circuit system 12), each routing channel including at least one track to route at least one wire. If desired, the interconnect circuitry may include pipeline elements, and the contents stored in these pipeline elements may be accessed during operation. For example, a programming circuit may provide read and write access to a pipeline element.

Note that other routing topologies, besides the topology of the interconnect circuitry depicted in FIG. 2, are intended to be included within the scope of the present disclosure. For example, the routing topology may include wires that travel diagonally or that travel horizontally and vertically along different parts of their extent as well as wires that are perpendicular to the device plane in the case of three-dimensional integrated circuits, and the driver of a wire may be located at a different point than one end of a wire. The routing topology may include global wires that span substantially all of the integrated circuit system 12, fractional global wires such as wires that span part of the integrated circuit system 12, staggered wires of a particular length, smaller local wires, or any other suitable interconnection resource arrangement.

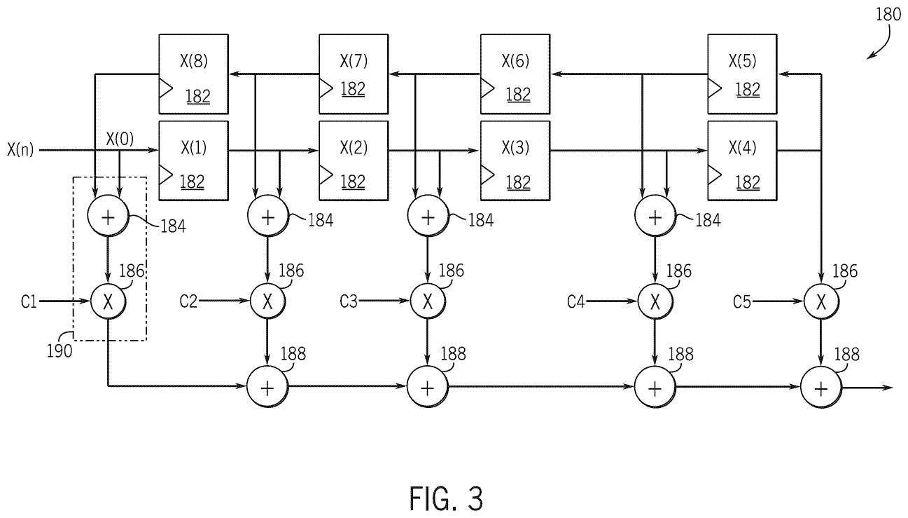

The integrated circuit 12 may be programmed to perform a wide variety of operations. One example shown in FIG. 3 is finite impulse response (FIR) filtering. For example, a FIR filter may be an asymmetric FIR filter in which weights applied to different taps may be different or, in the example of FIG. 3, may be a symmetric FIR filter 180 in which the weights are the same magnitude around some defined point. In the example of FIG. 3, the symmetric FIR filter 180 receives an input signal x(n). The FIR filter 180 illustrated in FIG. 3 has 9 taps symmetric to a point x(4) of the signal x(n) when the first point in the x(n) signals is x(0). The x(n) signal traverses registers 182 that provide the tap points into a pre-adder 184 before the results enter a multiplier 186 to multiply by a weight value (here, coefficients C1, C2, C3, C4, or C5). The partial results are summed together in adders 188 to obtain the result of the filter 180. The adders 184 and the multipliers 186 may be effectively grouped into a single operation 190 in some instances. In some cases, the weights may have the same magnitude, but a different sign. In such cases, the pre-adder 184 may be configurable as a presubtractor. The adders 188 may be separate addition circuits or a single large summation circuit.

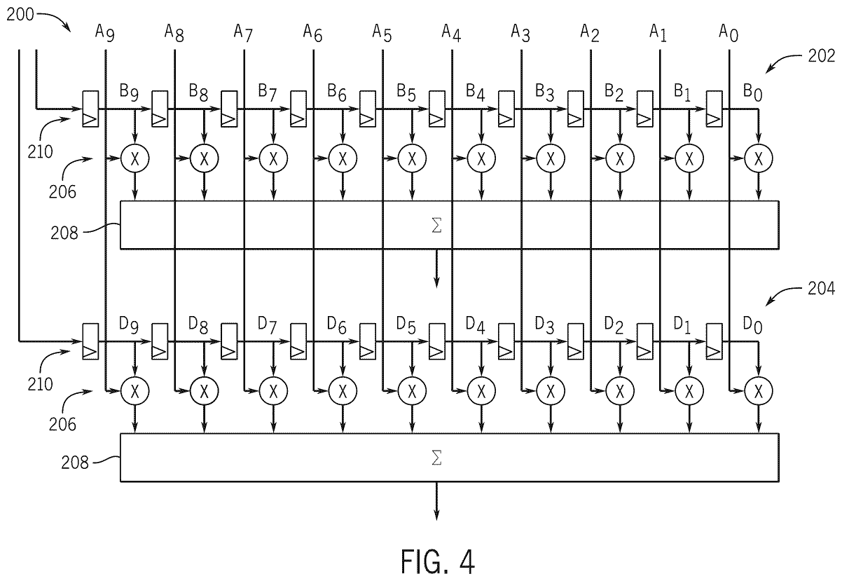

A wide variety of filters, such as the FIR filter 180 of FIG. 3, may be formed using circuitry of the integrated circuit system 12. The multiplication of the filters may take place using AI-related circuits on the DSP blocks 120 and/or large multipliers (e.g., 18×18 multipliers, 27×27 multipliers) of the DSP blocks 120. Indeed, the DSP blocks 120 may include tensor circuitry 200 as shown in FIG. 4. The tensor circuitry 200 may include multiple separate tensor circuits 202, 204. In the example of FIG. 4, the tensor circuitry 200 includes a first tensor circuit 202 and a second tensor circuit 204. Each tensor circuit 202, 204 includes a row of multipliers 206 that multiply a first input vector (e.g., composed of values A0, A1, . . . , A9) with a second input vector (e.g., composed of values B0, B1, . . . , B9 or values DO, D1, . . . , D9). The products of the multipliers 206 may be added together in summation circuitry 208 to produce an overall dot product. Registers 210 may shift in coefficients (e.g., filter weights, a vector) to be multiplied. Here, there are ten registers 210. As such, it may take ten cycles to load the tensor circuits 202, 204 with the coefficients, but once loaded, the coefficients may be used in any suitable number of multiplication operations with different inputs (e.g., the same value of B₀ may be used in multiplication operations with different values of A₀ without having to reload the registers 210).

It may be seen that the structure of the tensor circuits 202, 204 provide multiplication of inputs and summation of the resulting products, which are operations that also take place in many filters, such as the FIR filter 180 of FIG. 3. Yet the multipliers 206 may have a lower precision than employed in many filters. For example, the multipliers 206 may be a row of 6-bit, 7-bit, 8-bit, 9-bit, 10-bit, 11-bit, or 12-bit multipliers. By contrast, many filtering operations may have a precision of 16 bits or higher.

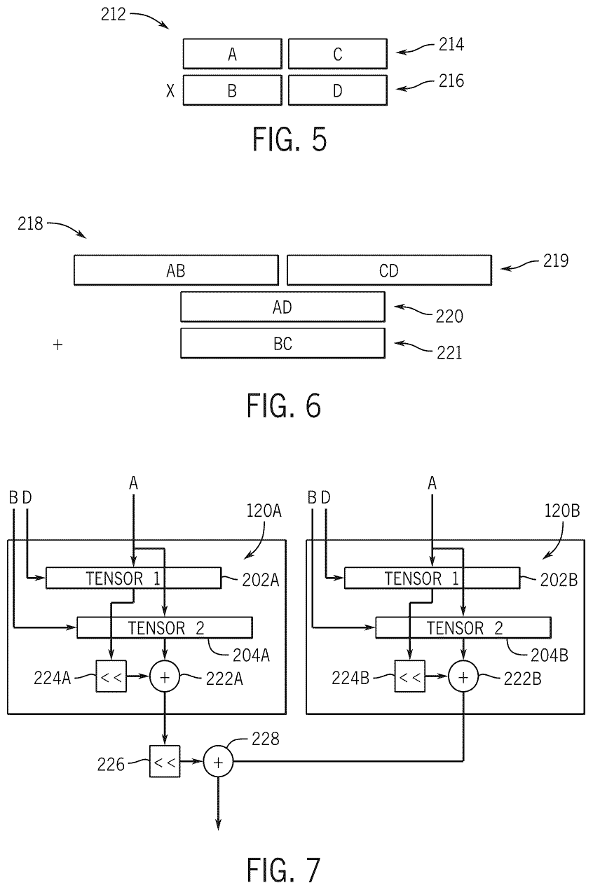

To achieve multiplication with a precision more commonly used in filtering operations, tensor circuits 202, 204 from multiple different DSP blocks 120 may be used in concert. For example, as shown in FIG. 5, a filtering operation may employ multiplication 212 involving two 16-bit numbers including a multiplicand 214 and a multiplier 216. The multiplicand 214 may be split into two 8-bit chunks A and C, and the multiplier 216 may be split into two 8-bit chunks B and D. Note that the sizes of the values are provided by way of example and may vary depending on the particular application and size of the multipliers of the tensor circuits 202 and 204. When calculating the sum of all of the multipliers 206, it is possible to sum together all lower chunks in the summation circuitry 208 of one of the tensor circuits 202 or 204, and separately all higher chunks in the summation circuitry 208 of the other of the tensor circuits 202 or 204, before adding the sum of the lower chunks to the sum of the upper chunks to form the result.

For example, an equivalent multiplication operation 218, shown in FIG. 6, is the addition of values 219, 220, and 221. The value 219 is a 32-bit value composed of the product AB and the product CD. The value 220 is a 16-bit value composed of the product AD. The value 221 is a 16-bit value composed of the product BC. Note that the product AB is a 16-bit value equivalent to a product of 8×8 bit multiplication of the values A and B of FIG. 5, the product CD is a 16-bit value equivalent to a product of an 8×8 bit multiplication of the values C and D of FIG. 5, the product AD is a 16-bit value equivalent to a product of an 8×8 bit multiplication of the values A and D of FIG. 5, and the product BC is a 16-bit value equivalent to a product of an 8×8 bit multiplication of the values B and C of FIG. 5.

As shown in FIG. 7, the multiplication operation 218 of FIG. 6 may be carried out using four tensor circuits 202A, 204A, 202B, 204B from two DSP blocks 120A and 120B. Each DSP block 120A and 120B may include respective addition circuitry 222A and 222B and bit-shifting circuitry 224A and 224B. Further bit-shifting circuitry 226 and 228 outside of the DSP blocks 120A and 120B may be formed in soft logic by programming the programmable logic circuitry (e.g., LABs 110) of the integrated circuit system 12.

To perform the multiplication operation 218 of FIG. 6 using the circuitry of FIG. 7, the value A (e.g., A₀ in FIG. 4) may be fed to a multiplier of the first tensor circuit 202A of the DSP block 120A and multiplied by the value D (e.g., Do in FIG. 4) to produce the product AD. Concurrently, the value A (e.g., A₀ in FIG. 4) may be fed to a multiplier of the second tensor circuit 204A of the DSP block 120A and multiplied by the value B (e.g., B₀ in FIG. 4) to produce the product AB. The result of the first tensor circuit 202A (the product AD) may be shifted to the right by 8 bits by the bit-shifting circuitry 224A and added together in the addition circuitry 222A. In parallel, the value C may be fed to a multiplier of the first tensor circuit 202B of the DSP block 120B and multiplied by the value D to produce the product CD. Concurrently, the value C may be fed to a multiplier of the second tensor circuit 204B of the DSP block 120B and multiplied by the value B to produce the product CB. The result of the first tensor circuit 202B (the product CD) may be shifted to the right by 8 bits by the bit-shifting circuitry 224B and added together in the addition circuitry 222B. To achieve the final alignment shown in FIG. 6, the sum of the result of the addition 222A may be shifted 8 bits to the left by the bit-shifting circuitry 226 and added together in the addition circuitry 228. As a result, the 8×8 bit multipliers of the tensor circuits 202A, 202B, 204A, and 204B can thus effectively operate collectively as 16×16 bit multipliers.

As may be appreciated, the operation discussed above relates to a single multiplication operation, but there may be many multiplication operations that are summed together in filtering operations. Because the tensor circuits 202A, 202B, 204A, and 204B include many multipliers and summation circuitry to sum the results, the tensor circuits 202A, 202B, 204A, and 204B may be used to form many higher-precision multipliers for filtering purposes. For example, if the tensor circuits 202A, 202B, 204A, and 204B each include ten respective 8×8 bit multipliers, the tensor circuits 202A, 202B, 204A, and 204B may collectively operate as ten 16×16 bit multipliers for filtering purposes using the technique discussed above.

Moreover, while the bit-shifting circuits inside the DSP blocks are described above as shifting by 8 bits to create a 16-bit multiplier, the bit-shifting circuits may shift by a different number of bits in different situations. Indeed, while shifting by 8 bits is sufficient for unsigned multipliers, signed multipliers constructed out of signed 8-bit tensor circuits 202, 204 may only be able to implement 15-bit signed multiplication. The shifting offsets in FIG. 6 are therefore either 7 bits or 8 bits. The bit-shifting circuitry 224 and 226 can be configurable to support several different numbers of bit shifts and/or directions right or left. Note that the other bit-shifting circuitry discussed elsewhere likewise may be configurable to shift by different numbers of bits (e.g., 7 or 8 bits) and/or different directions (e.g., left or right).

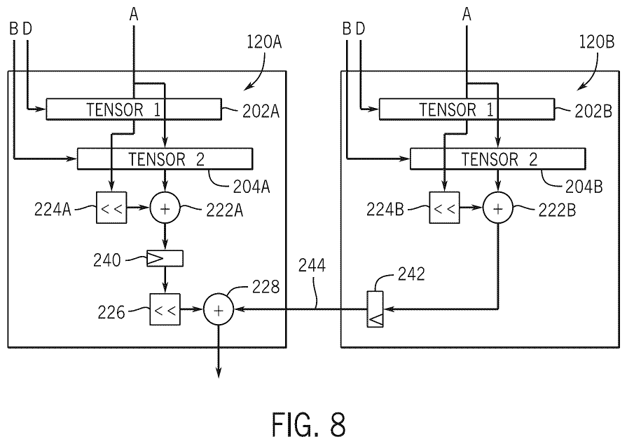

In the example of FIG. 7, the bit-shifting circuitry 226 and the addition circuitry 228 are formed in soft logic using programmable logic circuitry (e.g., LABs 110) of the integrated circuit system 12. In another example, shown in FIG. 8, the bit-shifting circuitry 226 and the addition circuitry 228 may be hardened circuitry within the DSP blocks 120. Balancing registers 240 and 242 may align the two asymmetric dot products from the the tensor circuits 202A and 202B and the tensor circuits 202A and 202B, respectively, which are shifted relative to each other and summed. A dedicated hardened inter-DSP communication channel 244 may pass the results from the second DSP block 120B to the first DSP block 120A. Thus, for example, the addition circuitry 228 may be implemented as a cascade adder used for the second tensor circuit 204A that is normally used for adding multiple tensors together when operating in an AI mode. The addition circuitry 228 for summation of the results of the tensor circuits 202A, 202B, 204A, and 204B in each block may also be may also be implemented using the cascade adder for the first tensor circuitry 202A. In other words, the addition circuitry 228 may not be an additional adder in some cases, but may be an existing adder (e.g., cascade adder, summation circuitry) that is reused by employing additional multiplexers to select the appropriate inputs.

As mentioned above, there may be many multiplication operations that are summed together in filtering operations. Indeed, referring back to the example tensor circuits 202, 204 shown in FIG. 4, a FIR filter may be implemented by inputting data into any number of the ten parallel inputs (e.g., A0, A1, . . . , A9), and loading the coefficients (e.g., B0, B1, . . . , B9) into the register chain formed using the registers 210. The data input can be connected via a delay line implemented in soft logic (e.g., LABs 110) of the integrated circuit system 12.

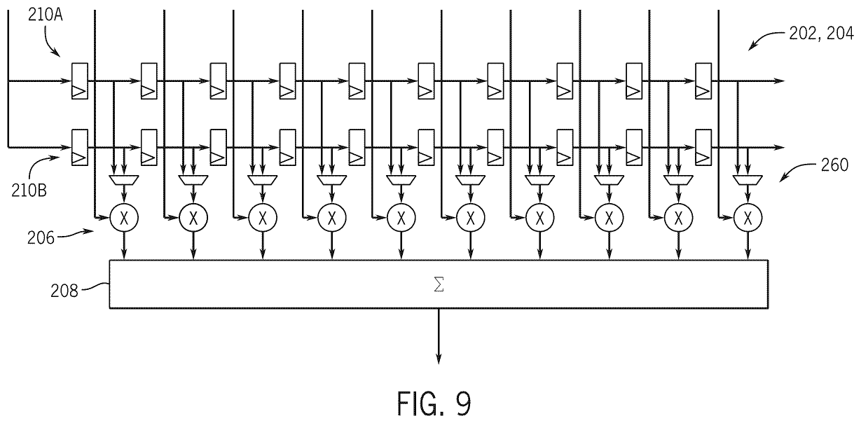

Additional sets of registers 210 may allow multiple sets of coefficients to be loaded, such that new coefficients may be loaded at the same time previously loaded coefficients are used in multiplication operations. FIG. 9 illustrates an example of a tensor circuit 202, 204 having two sets of registers 210A, 210B that can be loaded with two separate sets of coefficients. Multiplexers 260 may select between the coefficients to be multiplied. Here, there are two coefficient chains. In this way, one chain can be loaded while the other is used for operating, so there may be less or no dead time in the system. In other examples, there may be additional sets of registers 210 to provide additional coefficient chains.

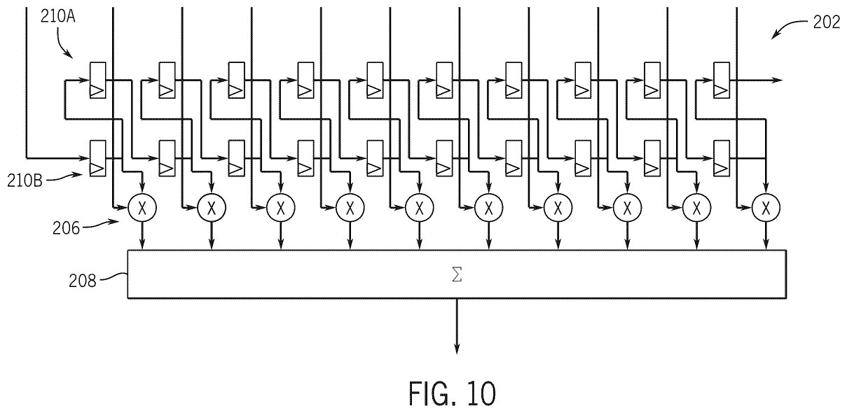

Another arrangement of the coefficient chains formed by the registers 210A and 210B for a tensor circuit 202 is shown in FIG. 10. This structure may be used for a variety of purposes, including to form a decimation filter. Rather than loading coefficients, the coefficient chains formed by the registers 210A and 210B may act as the delay chains for the data. The coefficients are then loaded in parallel with the ten inputs. Multiple channels or coefficient banks can be implemented using soft logic (e.g., LABs 110) of the integrated circuit system 12. The tensor circuit 202 structure of FIG. 10 may be used to form a decimation-by-two filter for a stream of data that alternately filters even data samples one register clock cycle, then odd data samples the next clock cycle, and so forth, as the samples are shifted through the registers 210A and 210B. While two sets of registers 210A and 210B are shown, additional sets of registers 210 may provide additional delays to enable other types of decimation filters (e.g., decimation-by-three filters, decimation-by-four filters) depending on the number of sets of registers that are used.

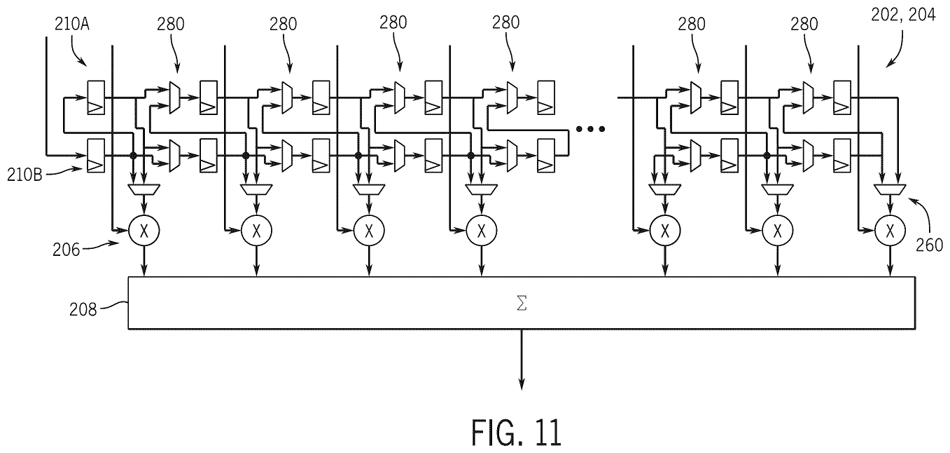

The tensor circuits 202, 204 may include additional circuitry to enable the filter arrangement of FIG. 10 as well as the previously described filtering techniques. For example, as shown by an example tensor circuit 202, 204 in FIG. 11, additional multiplexers 280 may enable data from the registers 210A and 210B to be routed in a variety of ways. For example, in one configuration, the multiplexers 280 allow the tensor circuit 202, 204 to load the registers 210B while the values in the registers 210A are used for operating. At a subsequent time, the values stored in the registers 210B may be shifted into the registers 210A, and the process may repeat. In another configuration, the multiplexers 280 allow the tensor circuit 202, 204 to operate as a decimation filter in the manner of FIG. 10.

In some cases, the tensor circuits 202, 204 may support different respective precisions. For example, the first tensor circuit 202 may have 10×10 bit multipliers while the second tensor circuit 204 may have 8×8 bit multipliers. Many filtering operations have historically used INT18 multiplication (e.g., 18×18 bit multiplication). It is difficult to create INT18 multiplier vectors out of INT10 and INT8 vectors, however, because one or two of the inputs of each vector is unsigned (making the multipliers 9×8 and 7×7). Even so, multiple DSP blocks 120 with tensor circuits 202, 204 having respective 10-bit and 8-bit precisions may be used to effectively perform 18×18 bit filtering. The products of the multipliers of the tensor circuits 202, 204 may be aligned in the manner discussed above to achieve an 18×18 multiplier with some lowest significant bit (LSB) errors. In fact, the upper 17 bits will always be correct.

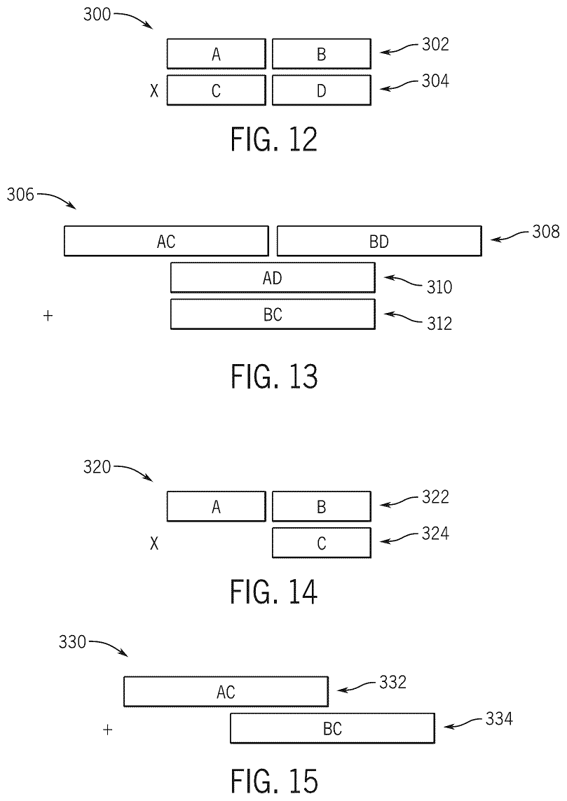

This is illustrated by an example multiplication operation 300 shown in FIG. 12. In FIG. 12, the multiplication operation 300 involves two 18-bit values including a multiplicand 302 and a multiplier 304. The multiplicand 214 may be split into an 8-bit signed chunk A and a 10-bit unsigned chunk B. The multiplier 304 may be split into an 8-bit signed chunk C and a 10-bit unsigned chunk D. FIG. 13 represents a substantially equivalent multiplication operation 306, involving the addition of values 308, 310, and 312. The value 308 is a value composed of the 8×8 bit product AC (signed x signed) and the 9×9 bit product BD (unsigned x unsigned). The value 310 is a value composed of the 9×8 bit product AD (signed x unsigned). The value 312 is a value composed of the 9×8 bit product BC (signed x unsigned).

The resulting 18×18 multiplication from using tensor circuits 202, 204 having 10×10 bit and 8×8 bit multiplier precisions, respectively, will be nearly equivalent to using 18×18 multipliers. An explanation follows. Consider that multiplier X and multiplicand Y inputs are split in two parts, an upper part of 8 bit and a lower 10-bit part:

$$X = A {2}^{10} + B \\ Y = C {2}^{10} + D$$

With A and C as 8-bit signed values, and B and D as 10-bit unsigned values, the product XY can be written as:

$$P = XY = AC {2}^{20} + A D {2}^{10} + B C {2}^{10} + B D .$$

Across two DSP Blocks 120, each having a respective tensor circuit 202 with 10-bit multipliers and a tensor circuit 204 with 8-bit multipliers, the resulting products may be described as follows:
AC=>8×8 multiplications, mapped to the narrow 8-bit mode of one of the DSP blocks 120.
AD=>8×10-bit multiplication, mapped on the wide 10-bit mode of one of the DSP blocks 120. Note that D is an unsigned value, so this multiplication is not actually a full one. Rather, D is reduced to 9 bits and is sign-extended (0 extended), with its lower bit dropped.
BC=>10×8-bit multiplication, which is a similar mapping to AD. B is reduced to 9 bits pre multiplication. This multiplication is mapped to the wide 10-bit mode of one of the DSP blocks 120.
BD=>10×10-bit unsigned multiplication, mapped to the narrow 8-bit mode.

The approximate value with this approach may be written as follows:

$$\tilde{P} = A C {2}^{20} + A \tilde{D} {2}^{10} + \tilde{B} C {2}^{10} + \tilde{{B}^{′}} \tilde{{D}^{′}}$$

The error introduced in this approach can thus be computed as:

$$P - \tilde{P} = A D {2}^{10} - A \tilde{D} {2}^{10} + B C {2}^{10} - \tilde{B} C {2}^{10} + BD - \tilde{{B}^{′}} = ( D - \tilde{D} ) A {2}^{10} + ( B - \tilde{B} ) C {2}^{10} + B D - B + B - \tilde{{B}^{′}} = ( D - \tilde{D} ) A {2}^{10} + ( B - \tilde{B} ) C {2}^{10} + B ( D - ) + ( B - \tilde{{B}^{′}} ) ( D - \tilde{D} ) ( A {2}^{10} ) + ( B - \tilde{B} ) ( C {2}^{10} ) + B ( D - ) + ( B - \tilde{{B}^{′}} )$$

Since D-\tilde{D} corresponds to the error introduced when truncating one bit (similar for B-\tilde{B}), the maximum error produced is “1”. The maximum error then occurs when:
A and C are maximum positive values on 8-bits signed (127)
B is the largest 10-bit unsigned integer (1023), and C is the largest positive value.

In this case, P-\tilde{P}=274,369, which corresponds to 1.000010111111000001_2*2∧(18). This means that, out of the 36 bits of the product, the top 17 bits are guaranteed to be correct. In fact, the upper 17 bits will always be correct. Indeed, when errors are calculated over 2²⁰ (that is, 1.04M) different possible values, the maximum error obtained is 267521, whereas the average error is 55416. In other words, the average error is equivalent to an average of 20 bits of the result being correct, whereas the maximum error is that the upper 17 bits will always be correct.

In addition to performing larger symmetric multiplication, tensor circuits 202 and 204 of the DSP blocks 120 may also be used to perform asymmetric multiplication. To perform asymmetric multiplication with a precision higher than any one multiplier from the tensor circuits 202 and 204, multiple tensor circuits 202, 204 from multiple different DSP blocks 120 may be used in concert. For example, as shown in FIG. 14, an asymmetric multiplication 320 may involve one 16-bit number (e.g., a multiplicand 322) and one 8-bit number (e.g., a multiplier 324). The multiplicand 322 may be split into two 8-bit chunks A and B and the multiplier 216 may remain as one 8-bit chunk C. Note that the sizes of the values are provided by way of example and may vary depending on the particular application and size of the multipliers of the tensor circuits 202 and 204.

An equivalent multiplication operation 330, shown in FIG. 15, is the addition of values 332 and 334. The value 332 is a 16-bit value composed of the product AC. The value 334 is a 16-bit value composed of the product BC. Note that the product AC is a 16-bit value equivalent to a product of 8×8 bit multiplication of the values A and C of FIG. 14 and the product AC is a 16-bit value equivalent to a product of an 8×8 bit multiplication of the values B and C of FIG. 14.

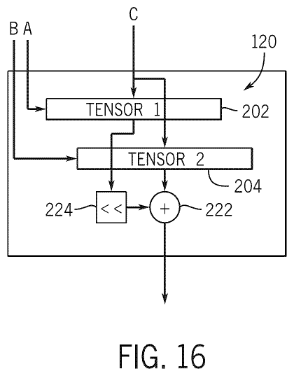

As shown in FIG. 16, the multiplication operation 330 of FIG. 15 may be carried out using two tensor circuits 202, 204 from one DSP block 120. To perform the multiplication operation 330 of FIG. 15 using the circuitry of FIG. 16, the value C (e.g., A₀ in FIG. 4) may be fed to a multiplier of the first tensor circuit 202 and multiplied by the value A (e.g., Do in FIG. 4) to produce the product AC. Concurrently, the value C (e.g., A₀ in FIG. 4) may be fed to a multiplier of the second tensor circuit 204 and multiplied by the value B (e.g., B₀ in FIG. 4) to produce the product BC. The result of the first tensor circuit 202 (the product AC) may be shifted to the left by 8 bits by the bit-shifting circuitry 224 and added together in the addition circuitry 222.

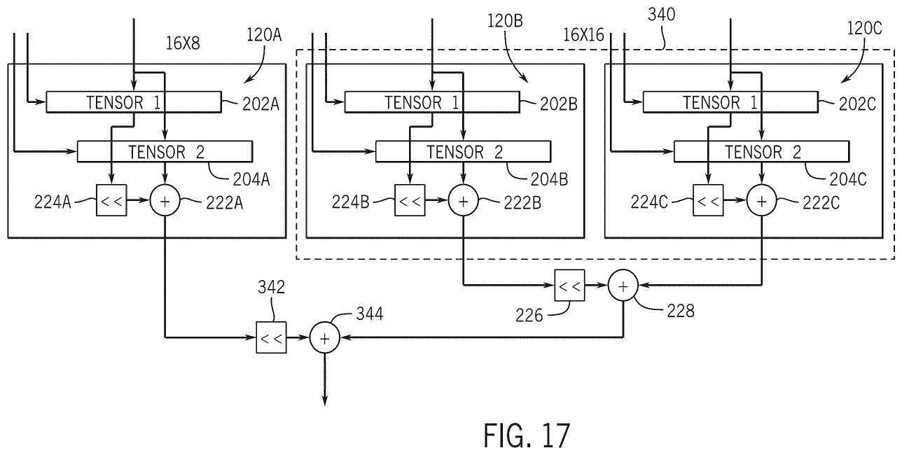

Other suitable multiplication operations may be performed using a variety of combinations of tensor circuits 202, 204 from different DSP blocks 120. Indeed, in some cases, a filter may contain coefficient values where one group of coefficients has a smaller precision (e.g., a maximum precision of 8 bits) and another group has a higher precision (e.g., a larger range, such as 16 bits). FIG. 17 shows how this type of filter may be efficiently constructed from a set of the DSP Blocks 120 arranged in both asymmetric and symmetric forms. For example, a first DSP block 120A may perform 16×8 bit multiplication using the tensor blocks 202A and 204A, shifting circuitry 224A, and addition circuitry 222A in the manner discussed above with reference to FIG. 16. Second and third DSP blocks 120B and 120C may collectively perform larger multiplication 340 (e.g., 16×16 bit multiplication), which may use the tensor blocks 202B, 204B, 202C, and 204C, shifting circuitry 224B and 224C, and addition circuitry 222B and 222C, as well as shifting circuitry 226 and addition circuitry 228 in the manner discussed above with reference to FIG. 7 or 8. The final result from the smaller multiplication of the first DSP block 120A may be shifted using shifting circuitry 342 and added to the final result from the larger multiplication 340 of the second and third DSP blocks 120B and 120C (as output by the adder 228) using addition circuitry 344. The shifting circuitry 226 and 342 and addition circuitry 228 and 344 may be hardened circuitry inside the DSP blocks 120A, 120B, and/or 120C, or may be soft logic implemented in programmable logic circuitry (e.g., LABs 110). For example, the 16-bit dot products can be constructed using two adjacent DSP Blocks 120B and 120C using entirely internal shifts and adds from circuitry within the DSP blocks 120B and 120C, and the asymmetric 8-bit dot products can be added using soft logic shifts and adds implemented in programmable logic circuitry.

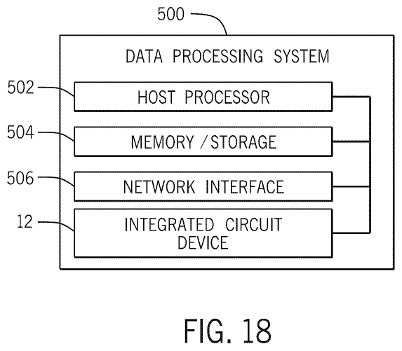

The circuits discussed above may be implemented on the integrated circuit system 12, which may be a component included in a data processing system, such as a data processing system 500, shown in FIG. 18. The data processing system 500 may include the integrated circuit system 12 (e.g., a programmable logic device), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 18 may include the integrated circuit system 12. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the integrated circuit system 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the hybrid modular multiplier may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

### EXAMPLE EMBODIMENTS

Example embodiments of the disclosure may include, among other things:

### Example Embodiment 1

An integrated circuit device comprising:
a first tensor circuit comprising a first set of multipliers of a first precision and first summation circuitry; and
a second tensor circuit comprising a second set of multipliers of a second precision and second summation circuitry;
wherein the first tensor circuit and the second tensor circuit are configurable to collectively perform a multiplication operation at a third precision higher than the first precision and the second precision.

### Example Embodiment 2

The integrated circuit device of example embodiment 1, comprising:
first bit-shifting circuitry configurable to bit-shift a result from the first tensor circuit in relation to a result from the second tensor circuit; and
first addition circuitry configurable to add the bit-shifted result from the first tensor circuit and the result from the second tensor circuit.

### Example Embodiment 3

The integrated circuit device of example embodiment 1, comprising:
a third tensor circuit comprising a third set of multipliers of the first precision and third summation circuitry; and
a fourth tensor circuit comprising a fourth set of multipliers of the second precision and second summation circuitry;
wherein the first tensor circuit, the second tensor circuit, the third tensor circuit, and the fourth tensor circuit are configurable to collectively perform a multiplication operation at a fourth precision higher than the first precision and the second precision.

### Example Embodiment 3

The integrated circuit device of example embodiment 3, wherein:
the first tensor circuit and the second tensor circuit are within a first digital signal processing block; and
the third tensor circuit and the fourth tensor circuit are within a second digital signal processing block;
wherein the integrated circuit device comprises:
a dedicated connection between the first digital signal processing block and the second digital signal processing block;
bit shifting circuitry configurable to bit-shift a result from the first digital signal processing block in relation to a result from the second digital signal processing block; and
addition circuitry configurable to sum the bit-shifted result from the first digital signal processing block and the result from the second digital signal processing block.

### Example Embodiment 4

The integrated circuit device of example embodiment 3, wherein the multiplication operation comprises obtaining a product equal to multiplying a first value by a second value, wherein:
the first tensor circuit is configurable to multiply a first part of the first value by a
first part of the second value;
the second tensor circuit is configurable to multiply the first part of the first value by a second part of the second value;
the third tensor circuit is configurable to multiply a second part of the first value by
the first part of the second value; and
the fourth tensor circuit is configurable to multiply the second part of the first value
by the second part of the second value.

### Example Embodiment 5

The integrated circuit device of example embodiment 4, comprising:
first bit-shifting circuitry configurable to bit-shift a first result from the first tensor circuit relative to a second result from the second tensor circuit;
second bit-shifting circuitry configurable to bit-shift a third result from the third tensor circuit relative to a fourth result from the fourth tensor circuit;
first addition circuitry configurable to add the first shifted result and the second result to obtain a fifth result;
second addition circuitry configurable to add the third shifted result and the fourth result to obtain a sixth result;
third bit-shifting circuitry configurable to bit-shift the fifth result relative to the sixth result; and
third addition circuitry configurable to add the fifth shifted result and the sixth result to obtain the product equal to multiplying the first value by the second value.

### Example Embodiment 6

The integrated circuit device of example embodiment 3, wherein the first tensor circuit, the second tensor circuit, the third tensor circuit, the fourth tensor circuit, the first bit-shifting circuitry, the second bit-shifting circuitry, the first addition circuitry, the second addition circuitry, the third bit-shifting circuitry, and the third addition circuitry are formed in hardened circuitry.

### Example Embodiment 7

The integrated circuit device of example embodiment 3, wherein the first precision is 8 bits, the second precision is 8 bits, and the fourth precision is 16×16 bits.

### Example Embodiment 8

The integrated circuit device of example embodiment 1, wherein the first precision is equal to the second precision.

### Example Embodiment 10

The integrated circuit device of example embodiment 1, wherein the first precision is different from the second precision.

### Example Embodiment 11

Filter circuitry comprising:
a plurality of tensor circuits configurable to multiply sets of components of input data with sets of components of weights;
bit-shifting circuitry configurable to shift a portion of the results output by the tensor circuits to produce shifted results; and
addition circuitry configurable to sum the shifted portion of the results with the non-shifted results to produce an output signal.

### Example Embodiment 12

The filter circuitry of example embodiment 11, wherein a first section of the filter circuitry comprises a first precision and a second section of the filter circuitry comprises a second precision.

### Example Embodiment 13

The filter circuitry of example embodiment 11, wherein a first set of the plurality of tensor circuits respectively comprise multipliers with inputs of the first precision and the second precision, wherein the first precision is different from the second precision.

### EXAMPLE EMBODIMENT 14

The filter circuitry of example embodiment 11, wherein:
the sets of components of the input data comprise:
a first data component holding a first set of most significant bits of a first input data value; and
a second data component holding a second set of least significant bits of the first input data value; and
the sets of components of the weights comprise:
a first weight component holding a first set of most significant bits of a first weight value; and
a second weight component holding a second set of least significant bits of the first weight value.

### Example Embodiment 15

The filter circuitry of example embodiment 11, wherein the tensor circuits comprise a first set of registers and a second set of registers, wherein the first set of registers is configurable to store a first portion of the sets of components of the input data or the sets of components of the weights to use to perform multiplication operations while a second portion of the sets of components of the input data or the sets of components of the weights are loaded via the second set of registers.

### Example Embodiment 16

The filter circuitry of example embodiment 11, wherein the tensor circuits comprise a first set of registers and a second set of registers and are configurable to implement a decimation filter, wherein the first set of registers is configurable to store a first portion of the sets of components of the input data representing one of even data samples and odd data samples, and wherein the second set of registers is configurable to store a second portion of the sets of components of the input data representing the other of the even data samples and odd data samples, wherein the tensor circuits are configurable to perform multiplication operations based on the storage from the first set of registers, and wherein the first set of registers is configurable to shift data to the second set of registers and the second set of registers is configurable to shift data to the first set of registers between multiplication operations.

### Example Embodiment 17

A programmable logic device comprising:
programmable logic circuitry configurable to implement soft logic circuits; and
embedded digital signal processing blocks configurable to perform mathematical operations based on hardened logic circuitry, wherein at least some of the digital signal processing blocks comprise:
   a tensor circuit comprising:
a set of multiplier circuits configurable to multiply respective multiplicand values with multiplier values;
a first set of registers configurable to store a first set of the multiplier values;
a second set of registers configurable to store a second set of the multiplier values;
a first set of multiplexers, wherein each multiplexer of the first set of multiplexers receives inputs from one of the first set of registers and one of the second set of registers and selectively outputs to one of the set of multiplier circuits;
a second set of multiplexers, wherein each multiplexer of the second set of multiplexers receives inputs from one of the first set of registers and one of the second set of registers and selectively outputs to a next one of the first set of registers; and
a third set of multiplexers, wherein each multiplexer of the first set of multiplexers receives inputs from one of the first set of registers and one of the second set of registers and selectively outputs to a next one of the second set of registers.

### Example Embodiment 18

The programmable logic device of example embodiment 17, wherein the tensor circuit is configurable to be used in a decimation filter, wherein the first set of the multiplier values corresponds to even or odd data samples and the second set of the multiplier values corresponds to the other of even or odd data samples.

### Example Embodiment 19

The programmable logic device of example embodiment 17, wherein the tensor circuit is configurable to be used in a finite impulse response filter that operates on the first set of multiplier values while the second set of the multiplier values is being loaded.

### Example Embodiment 20

The programmable logic device of example embodiment 17, wherein the tensor circuit has a first precision or a second precision and wherein multiple digital signal processing blocks are configurable to collectively perform a multiplication operation at a third precision higher than the first precision and the second precision.

What is claimed is:

1. An integrated circuit device comprising:
a first tensor circuit comprising a first set of multipliers of a first precision and first summation circuitry; and
a second tensor circuit comprising a second set of multipliers of a second precision and second summation circuitry;
wherein the first tensor circuit and the second tensor circuit are configurable to collectively perform a multiplication operation at a third precision higher than the first precision and the second precision.

2. The integrated circuit device of claim 1, comprising:
first bit-shifting circuitry configurable to bit-shift a result from the first tensor circuit in relation to a result from the second tensor circuit; and
first addition circuitry configurable to add the bit-shifted result from the first tensor circuit and the result from the second tensor circuit.

3. The integrated circuit device of claim 1, comprising:
a third tensor circuit comprising a third set of multipliers of the first precision and third summation circuitry; and
a fourth tensor circuit comprising a fourth set of multipliers of the second precision and second summation circuitry;
wherein the first tensor circuit, the second tensor circuit, the third tensor circuit, and the fourth tensor circuit are configurable to collectively perform a multiplication operation at a fourth precision higher than the first precision and the second precision.

4. The integrated circuit device of claim 3, wherein:
the first tensor circuit and the second tensor circuit are within a first digital signal processing block; and
the third tensor circuit and the fourth tensor circuit are within a second digital signal processing block;
wherein the integrated circuit device comprises:
a dedicated connection between the first digital signal processing block and the second digital signal processing block;
bit shifting circuitry configurable to bit-shift a result from the first digital signal processing block in relation to a result from the second digital signal processing block; and
addition circuitry configurable to sum the bit-shifted result from the first digital signal processing block and the result from the second digital signal processing block.

5. The integrated circuit device of claim 3, wherein the multiplication operation comprises obtaining a product equal to multiplying a first value by a second value, wherein:
the first tensor circuit is configurable to multiply a first part of the first value by a first part of the second value;
the second tensor circuit is configurable to multiply the first part of the first value by a second part of the second value;
the third tensor circuit is configurable to multiply a second part of the first value by the first part of the second value; and
the fourth tensor circuit is configurable to multiply the second part of the first value by the second part of the second value.

6. The integrated circuit device of claim 4, comprising:
first bit-shifting circuitry configurable to bit-shift a first result from the first tensor circuit relative to a second result from the second tensor circuit;
second bit-shifting circuitry configurable to bit-shift a third result from the third tensor circuit relative to a fourth result from the fourth tensor circuit;
first addition circuitry configurable to add the first shifted result and the second result to obtain a fifth result;
second addition circuitry configurable to add the third shifted result and the fourth result to obtain a sixth result;
third bit-shifting circuitry configurable to bit-shift the fifth result relative to the sixth result; and
third addition circuitry configurable to add the fifth shifted result and the sixth result to obtain the product equal to multiplying the first value by the second value.

7. The integrated circuit device of claim 3, wherein the first tensor circuit, the second tensor circuit, the third tensor circuit, the fourth tensor circuit, the first bit-shifting circuitry, the second bit-shifting circuitry, the first addition circuitry, the second addition circuitry, the third bit-shifting circuitry, and the third addition circuitry are formed in hardened circuitry.

8. The integrated circuit device of claim 3, wherein the first precision is 8 bits, the second precision is 8 bits, and the fourth precision is 16×16 bits.

9. The integrated circuit device of claim 1, wherein the first precision is equal to the second precision.

10. The integrated circuit device of claim 1, wherein the first precision is different from the second precision.

11. Filter circuitry comprising:
a plurality of tensor circuits configurable to multiply sets of components of input data with sets of components of weights;
bit-shifting circuitry configurable to shift a portion of the results output by the tensor circuits to produce shifted results; and
addition circuitry configurable to sum the shifted portion of the results with the non-shifted results to produce an output signal.

12. The filter circuitry of claim 11, wherein a first section of the filter circuitry comprises a first precision and a second section of the filter circuitry comprises a second precision.

13. The filter circuitry of claim 11, wherein a first set of the plurality of tensor circuits respectively comprise multipliers with inputs of the first precision and the second precision, wherein the first precision is different from the second precision.

14. The filter circuitry of claim 11, wherein:
the sets of components of the input data comprise:
a first data component holding a first set of most significant bits of a first input data value; and
a second data component holding a second set of least significant bits of the first input data value; and
the sets of components of the weights comprise:
a first weight component holding a first set of most significant bits of a first weight value; and
a second weight component holding a second set of least significant bits of the first weight value.

15. The filter circuitry of claim 11, wherein the tensor circuits comprise a first set of registers and a second set of registers, wherein the first set of registers is configurable to store a first portion of the sets of components of the input data or the sets of components of the weights to use to perform multiplication operations while a second portion of the sets of components of the input data or the sets of components of the weights are loaded via the second set of registers.

16. The filter circuitry of claim 11, wherein the tensor circuits comprise a first set of registers and a second set of registers and are configurable to implement a decimation filter, wherein the first set of registers is configurable to store a first portion of the sets of components of the input data representing one of even data samples and odd data samples, and wherein the second set of registers is configurable to store a second portion of the sets of components of the input data representing the other of the even data samples and odd data samples, wherein the tensor circuits are configurable to perform multiplication operations based on the storage from the first set of registers, and wherein the first set of registers is configurable to shift data to the second set of registers and the second set of registers is configurable to shift data to the first set of registers between multiplication operations.

17. A programmable logic device comprising:
programmable logic circuitry configurable to implement soft logic circuits; and
embedded digital signal processing blocks configurable to perform mathematical operations based on hardened logic circuitry, wherein at least some of the digital signal processing blocks comprise:
a tensor circuit comprising:
a set of multiplier circuits configurable to multiply respective multiplicand values with multiplier values;
a first set of registers configurable to store a first set of the multiplier values;
a second set of registers configurable to store a second set of the multiplier values;
a first set of multiplexers, wherein each multiplexer of the first set of multiplexers receives inputs from one of the first set of registers and one of the second set of registers and selectively outputs to one of the set of multiplier circuits;
a second set of multiplexers, wherein each multiplexer of the second set of multiplexers receives inputs from one of the first set of registers and one of the second set of registers and selectively outputs to a next one of the first set of registers; and
a third set of multiplexers, wherein each multiplexer of the first set of multiplexers receives inputs from one of the first set of registers and one of the second set of registers and selectively outputs to a next one of the second set of registers.

18. The programmable logic device of claim 17, wherein the tensor circuit is configurable to be used in a decimation filter, wherein the first set of the multiplier values corresponds to even or odd data samples and the second set of the multiplier values corresponds to the other of even or odd data samples.

19. The programmable logic device of claim 17, wherein the tensor circuit is configurable to be used in a finite impulse response filter that operates on the first set of multiplier values while the second set of the multiplier values is being loaded.

20. The programmable logic device of claim 17, wherein the tensor circuit has a first precision or a second precision and wherein multiple digital signal processing blocks are configurable to collectively perform a multiplication operation at a third precision higher than the first precision and the second precision.
